(19) United States
(12) Patent Application Publication
(10) Pub. No.: US 2014/0317271 A1
(43) Pub. Date: Oct. 23, 2014

(54) METHOD AND NODE APPARATUS FOR COLLECTING INFORMATION IN CONTENT NETWORK BASED ON INFORMATION-CENTRIC NETWORKING

(71) Applicant: ELECTRONICS AND TELECOMMUNICATIONS RESEARCH INSTITUTE, Daejeon (KR)

(72) Inventors: Byeongsik KIM, Daejeon (KR); Tae Yeon KIM, Daejeon (KR); Dong Myoung BAEK, Daejeon (KR); Seung Hyun YOON, Daejeon (KR); Byung Joon LEE, Daejeon (KR); Hong Seok JEON, Daejeon (KR); Hyung Seok CHUNG, Daejeon (KR); Ho Young SONG, Daejeon (KR)

(73) Assignee: ELECTRONICS AND TELECOMMUNICATIONS RESEARCH INSTITUTE, Daejeon (KR)

(21) Appl. No.: 14/096,814

(22) Filed: Dec. 4, 2013

(30) Foreign Application Priority Data
Apr. 18, 2013 (KR) 10-2013-0043130

(51) Int. Cl. H04L 12/24; G06F 17/30

(52) U.S. Cl. CPC H04L 41/0853; G06F 17/30345
USPC 709/224

(57) ABSTRACT

In a content network over which a plurality of smart nodes is coupled, each smart node receives advertisement messages broadcasted by adjacent smart nodes. The advertisement message may be one of a link state advertisement (LSA) message including link state information indicative of a link that is a network interface, a server state advertisement (SSA) message including server state information indicative of a data storage state and a processing state of a processing unit of the smart node, and a content state advertisement (CSA) message including content state information indicative of content stored in the smart node. Each smart node updates its own database based on the information included in the received advertisement message.

### CROSS-REFERENCE TO RELATED APPLICATION

This application claims priority to and the benefit of Korean Patent Application No. 10-2013-0043130 filed in the Korean Intellectual Property Office on Apr. 18, 2013, the entire contents of which are incorporated herein by reference.

### BACKGROUND OF THE INVENTION

(a) Field of the Invention

The present invention relates to a method of collecting information and, more particularly, to a method of collecting pieces of information necessary to manage a content network based on information-centric networking in the content network and a node apparatus for performing the same.

(b) Description of the Related Art

Information-centric networking is a concept that attempts to change an existing Internet communication method in which end-to-end communication is performed between hosts into a paradigm in which communication is performed between hosts based on information. In information-centric networking, each host trying to perform communication does so using an identifier for information to be communicated without using the address of a counterpart host. A network system determines what information has to be served based on an identifier for corresponding information and sends the corresponding information.

A content network is a network that moves content, desired by a user, as close as possible to the user using a caching server, thereby significantly improving transmission speed of the content.

In order to configure a content network, a method of efficiently transferring content data, a method of efficiently storing data in a server and processing data, and a method of efficiently routing content data in order to provide efficient service to a user in addition to simply displacing content to the location of the user are necessary.

However, conventional techniques are very restricted to limited parts, such as a technique for caching content and a technique for routing content, and a method of efficiently processing and managing content in a content network based on information-centric networking is not being developed.

### SUMMARY OF THE INVENTION

The present invention has been made in an effort to provide a method and node apparatus for collecting information in a content network based on information-centric networking having an advantage of being capable of efficiently collecting information for managing the content network.

An exemplary embodiment of the present invention provides a method of collecting information in a content network over which a plurality of smart nodes is coupled, including: each of the smart nodes receiving advertisement messages broadcasted by adjacent smart nodes; the smart node determining whether each of the received advertisement messages is one of a link state advertisement (LSA) message including link state information indicative of a link that is a network interface, a server state advertisement (SSA) message including server state information indicative of the data storage state and the processing state of a processing unit of the smart node, and a content state advertisement (CSA) message including content state information indicative of content stored in the smart node; the smart node updating a corresponding database based on the information included in the received advertisement message based on a result of the determination; and the smart node generating an advertisement message including changed information when link state information, server state information, or content state information stored in the smart node is changed in response to the update of the corresponding database and broadcasting the generated advertisement message.

The smart node may retain link state information, server state information, and content state information about all the smart nodes connected to the content network based on the advertisement messages broadcasted by the respective smart nodes.

Furthermore, a content network management system may only be connected to a relay smart node that is one of the plurality of smart nodes. The method may further include the content network management system obtaining the link state information, the server state information, and the content state information about the smart nodes connected to the content network based on the advertisement messages broadcasted through the relay smart node.

Updating the corresponding database may include: updating its own link state database based on contents included in the LSA message if, as a result of the determination, the received advertisement message is the LSA message; updating its own server state database based on contents included in the SSA message if, as a result of the determination, the received advertisement message is the SSA message; and updating its own content state database based on contents included in the CSA message if, as a result of the determination, the received advertisement message is the CSA message.

The link state information may include at least one of the identifier of a first interface which is newly formed in the smart node or whose contents have been changed, an IP address of the first interface, adjacent node interface identifiers that are interface identifiers of adjacent smart nodes connected to the first interface, IP addresses of adjacent node interfaces that are IP addresses of interfaces of adjacent smart nodes connected to the first interface, a total bandwidth of the first interface, and an available bandwidth of the first interface.

The server state information may include at least one of a smart node identifier, total capacity of the data storage unit for storing content, capacity of a data storage unit currently being used, an amount of a processing unit being used, total capacity of a memory, and a capacity of memory being used.

Furthermore, the content state information may include a smart node identifier, a content identifier, and a chunk identifier.

Another embodiment of the present invention provides a method of collecting information in a content network over which a plurality of smart nodes is coupled, including: a content network management system connected to a relay smart node, that is, one of the plurality of smart nodes, generating an information request message, and sending the generated information request message to the relay smart node; and the content network management system receiving an information response message corresponding to an information request message through the relay smart node. The information request message may include an identifier of one of a database for storing link state information indicative of a link that is a network interface, a database for storing server state information indicative of a data storage state and a processing state of the processing unit of each smart node, and a database for storing content state information indicative of content stored in each smart node, wherein the databases are included in the content network management system.

The information response message may include database contents that are one of link state information, server state information, and content state information corresponding to a database identifier included in the information request message.

The method may further include: the relay smart node receiving the information request message from the content network management system; the relay smart node sending the received information request message to adjacent smart nodes; the relay smart node receiving the information response message corresponding to the information request message from an adjacent smart node; and the relay smart node sending the information response message to the content network management system.

The relay smart node sending the information response message to the content network management system may include: the relay smart node updating its own corresponding database based on database contents included in the information response message received from the adjacent smart node; the relay smart node generating an information response message including the updated database contents; and the relay smart node sending the generated information response message to the content network management system.

Another embodiment of the present invention provides a node apparatus connected to a content network over which a plurality of smart nodes is coupled, including: a link state database for storing link state information about a link that is a network interface connected to a specific smart node of the content network; a server state database for storing server state information indicative of the data storage state and the processing state of the processing unit of the specific smart node of the content network; a content state database for storing content state information indicative of content stored in the specific smart node of the content network; an advertisement message processing unit for sending an advertisement message including information related to a generated change when one of the link state database, the server state database, and the content state database is changed, and receiving advertisement messages from other smart nodes; and a processing unit for updating one of the link state database, the server state database, and the content state information database based on the information included in the received advertisement message.

The node apparatus may further include: a caching storage unit for receiving content in a chunk unit and caching the received content; a data storage unit for storing data including the content; and a memory.

If an information request message generated from a content network management system connected to a relay smart node that is one of the plurality of smart nodes is received, the node apparatus may send an information response message including contents of a database corresponding to a database identifier included in the information request message, from among the link state database, the server state database, and the content state database.

The node apparatus may store and manage pieces of link state information, server state information, and content state information about all the smart nodes connected to the content network in respective databases.

### BRIEF DESCRIPTION OF THE DRAWINGS

FIG. 1 is a diagram showing a content network based on information-centric networking in accordance with an exemplary embodiment of the present invention.

FIG. 2 is a diagram showing a link state database (LSDB) including link state information in accordance with an exemplary embodiment of the present invention.

FIG. 3 is a diagram showing a server state database (SSDB) including server state information in accordance with an exemplary embodiment of the present invention.

FIG. 4 is a diagram showing a content state database (CSDB) including content state information in accordance with an exemplary embodiment of the present invention.

FIG. 5 is a diagram showing the structure of a smart node in accordance with an exemplary embodiment of the present invention.

FIG. 6 is a diagram showing a relationship between a smart node and a content network management system in an exemplary embodiment of the present invention.

FIG. 7 is a flowchart illustrating a method of collecting information using an advertisement message in accordance with an exemplary embodiment of the present invention.

FIG. 8 is an exemplary diagram showing a state in which a link state advertisement (LSA) message is advertised in accordance with an exemplary embodiment of the present invention.

FIG. 9 is an exemplary diagram showing a state in which a server state advertisement (SSA) message is advertised in accordance with an exemplary embodiment of the present invention.

FIG. 10 is an exemplary diagram showing a state in which a content state advertisement (CSA) message is advertised in accordance with an exemplary embodiment of the present invention.

FIG. 11 is a flowchart illustrating a method of collecting information in the content network management system in accordance with an exemplary embodiment of the present invention, and FIG. 12 is a diagram showing a message transmission/reception relationship between the content network management system and smart nodes.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

In the entire specification and claims, unless explicitly described to the contrary, the word “comprise” and variations such as “comprises” or “comprising” will be understood to imply the inclusion of stated elements but not the exclusion of any other elements.

A method and apparatus for collecting information in a content network in accordance with exemplary embodiments of the present invention are described below.

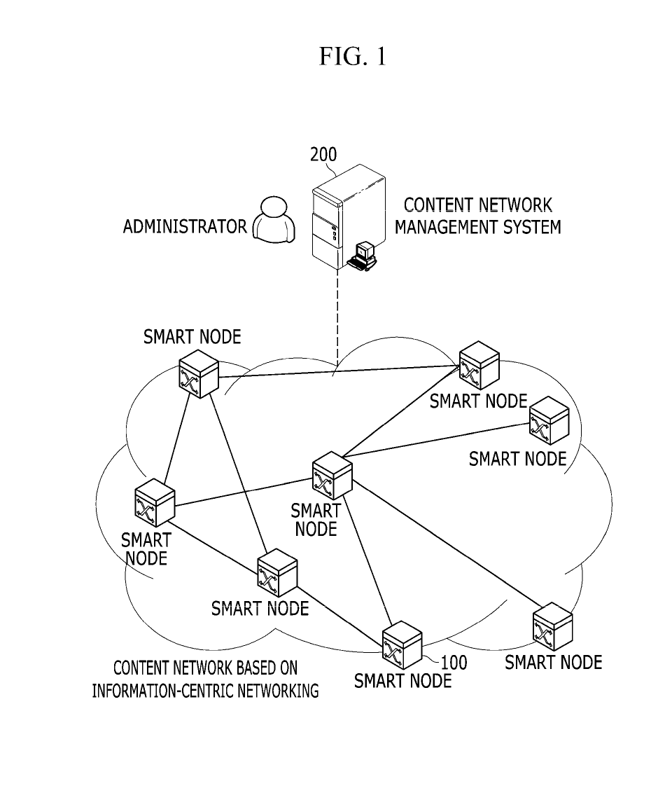

FIG. 1 is a diagram showing a content network based on information-centric networking in accordance with an exemplary embodiment of the present invention.

As shown in FIG. 1, the content network includes a plurality of smart nodes (assigned a representative number “100”) and a content network management system 200 connected to the smart nodes.

The content network management system 200 is a separate system that enables an operator to manage a content network based on information-centric networking. The content network management system 200 collects pieces of information necessary to manage a content network based on information-centric networking, and manages the content network based on information-centric networking based on the pieces of collected information. The content network management system 200 may perform control over a content network based on information-centric networking.

The smart node 100 sends content based on an identifier. The smart node 100 can perform a server function of storing high-capacity content and a function of caching content located in another smart node for users located nearby, in addition to the function of sending content based on an identifier.

The smart node 100 can further perform a method of efficiently transferring content data, a method of efficiently storing data in a server and processing data, and a method of efficiently routing content data in order to provide efficient service to a user.

The smart node 100 has information about the state of smart nodes present in the entire network. This information is obtained based on an advertisement message received from each smart node. This is described in more detail below.

The content network management system 200 is physically connected to a specific smart node that is present in a content network based on information-centric networking, as shown in FIG. 1. In an exemplary embodiment of the present invention, the content network management system 200 is connected to only one specific smart node without being connected to all smart nodes because all smart nodes have the same state information about the smart nodes present in the entire network according to the advertisement messages.

In an exemplary embodiment of the present invention, pieces of information managed by the content network management system 200 can be chiefly classified into three groups: link state information, server state information, and content state information.

The content network management system 200 can include a link state database (LSDB), a server state database (SSDB), and a content state database (CSDB) in order to manage the pieces of the information. Each smart node 100 can be implemented to include those databases and configured to manage link state information, server state information, and content state information.

Pieces of information collected and managed in a content network information-centric networking in accordance with an exemplary embodiment of the present invention are as follows.

TABLE 1

| Information identifier | Description |
|---|---|
| Total_Datastore | Total capacity of smart node data storage unit |
| Used_Datastore | Capacity of smart node data storage unit that is |
| | currently being used |
| Content_ID | Identifiers of pieces of content stored in smart |
| | node data storage unit |
| Chunk_ID | Identifiers of chunks stored in smart node caching |
| | storage unit |
| Used_CPU | Capacity of smart node processor (CPU) used |
| Total_Memory | Total capacity of smart node memory |
| Used_Memory | Capacity of smart node memory that is currently |
| | being used |
| Inf | Pieces of information about network interfaces |

Here, pieces of information “Inf” about network interfaces include pieces of information listed in Table 2 below.

TABLE 2

| Information identifier | Description |
|---|---|
| Inf_ID | Identifier for interface (e.g., interface name, such |
| | as “eth0”) |
| Inf_IP | IP address for interface |
| Neighbor_IF | Interface identifier of adjacent smart node |
| | connected to corresponding interface |
| Neighbor_IP | IP address for interface of neighbor smart node |
| | connected to corresponding interface |
| Total_BW | Total bandwidth for physical communication link |
| | connected to corresponding interface |
| Available_BW | Available bandwidth for interface |

From among the pieces of information, the link state information includes pieces of information “Inf” about network interfaces.

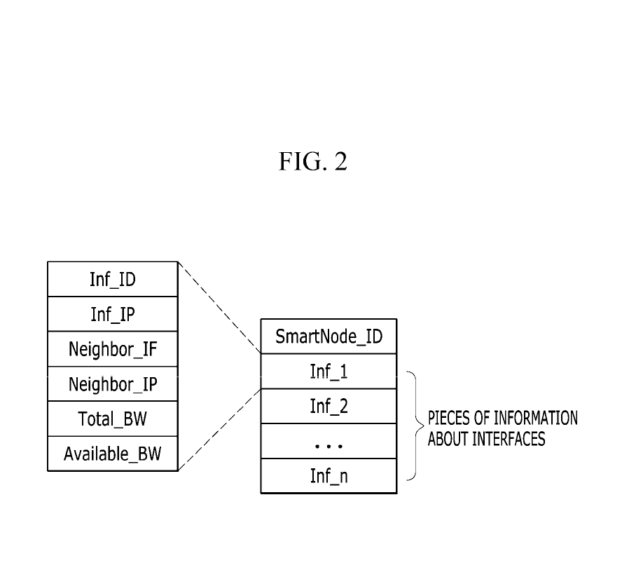

FIG. 2 is a diagram showing an LSDB including link state information in accordance with an exemplary embodiment of the present invention.

As shown in FIG. 2, the LSDB includes link state information, that is, Inf_ID, Inf_IP, Neighbor_IF, Neighbor_IP, Total_BW, and Available_BW, and particularly, includes link state information for each link, that is, an interface formed in each smart node. For example, if a plurality of links 1, . . . , n are present for a specific smart node (node identifier: SmartNode_ID), the LSDB includes pieces of information Inf_{—}1, . . . , Inf_n about network interfaces for respective links. Each of the pieces of information Inf_{—}1, . . . , Inf_n about the network interfaces for the respective links includes Inf_ID, Inf_IP, Neighbor_IF, Neighbor_IP, Total_BW, and Available_BW for each link.

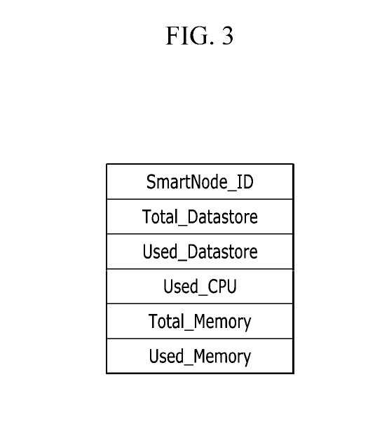

Meanwhile, the server state information is described with reference to FIG. 3.

FIG. 3 is a diagram showing a server state database (SSDB) including server state information in accordance with an exemplary embodiment of the present invention.

Each smart node constructs an SSDB including server state information, and the content network management system can construct the same SSDB. Link state information stored in the SSDB indicates a data storage state and the processing state of a processing unit, and includes Total_Datastore, Used_Datastore, Used_CPU, Total_Memory, and Used_Memory corresponding to SmartNode_ID, that is, a smart node identifier, as shown in FIG. 2.

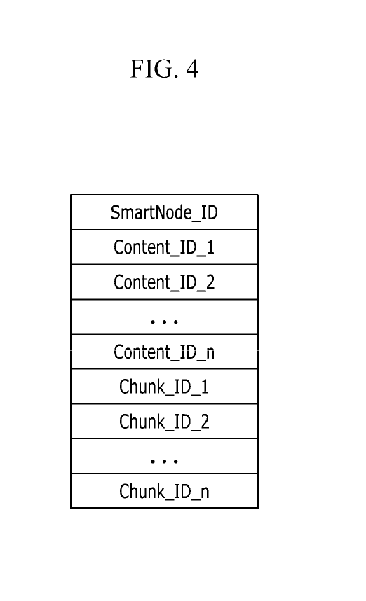

Furthermore, content state information is described with reference to FIG. 4.

FIG. 4 is a diagram showing a content state database (CSDB) including content state information in accordance with an exemplary embodiment of the present invention.

Each smart node constructs a CSDB including content state information, and the content network management system can also construct the same CSDB. Content state information stored in the CSDB indicates information about content stored in a smart node, and includes Content_ID and Chunk_ID corresponding to SmartNode_ID, that is, a smart node identifier, as shown in FIG. 4. For example, the content state information can include Content_ID_{—}1, Content_ID, Chunk_ID_{—}2, . . . , Content_ID_n, Chunk_ID_{—}1 Chunk_ID_{—}2, . . . , Chunk_ID_n.

In an exemplary embodiment of the present invention, the above-described link state information, server state information, and content state information are collected using advertisement messages, and the LSDB, the SSDB, and the CSDB are constructed using the pieces of information.

To this end, in an exemplary embodiment of the present invention, a new advertisement message is used to advertise information about a server and information about content. A server state advertisement (SSA) message is used to transfer information about a server, and a content state advertisement (CSA) message is used to transfer information about content. Furthermore, a link state advertisement (LSA) message is used to transfer information about links.

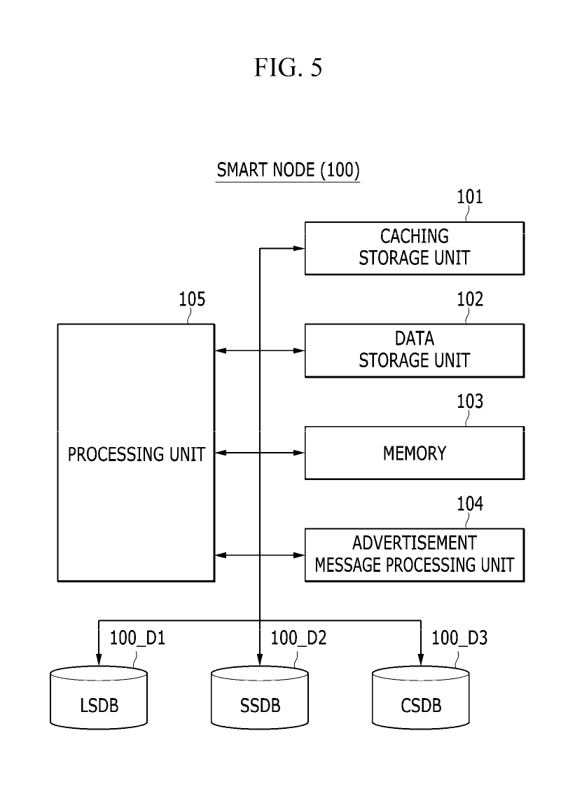

FIG. 5 is a diagram showing the structure of the smart node in accordance with an exemplary embodiment of the present invention.

The smart node 100 is also called a node apparatus. The smart node 100 includes an LSDB 100_D1 for managing link state information, an SSDB 100_D2 for managing server state information, and a CSDB 100_D3 for managing content state information, as shown in FIG. 5.

The smart node 100 further includes a caching storage unit 101 for receiving content in a chunk unit and managing the received content, a data storage unit 102 for storing data (including content) collected from and managed by nodes, a memory 103, an advertisement message processing unit 104 for generating an advertisement message, sending the generated advertisement message, and processing received advertisement messages, and a processing unit 105 for controlling the units 101, 102, and 104 and the memory 103 for the purpose of content processing and message transmission/reception processing in the smart node.

The caching storage unit 101 performs a function of caching content for user terminals located nearby, and the processing unit 105 performs a function of sending content based on an identifier.

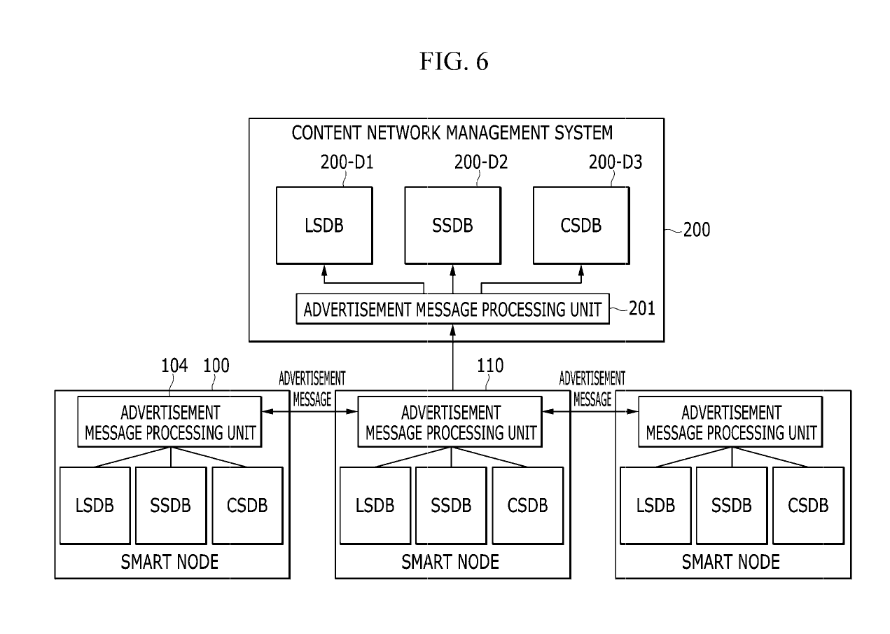

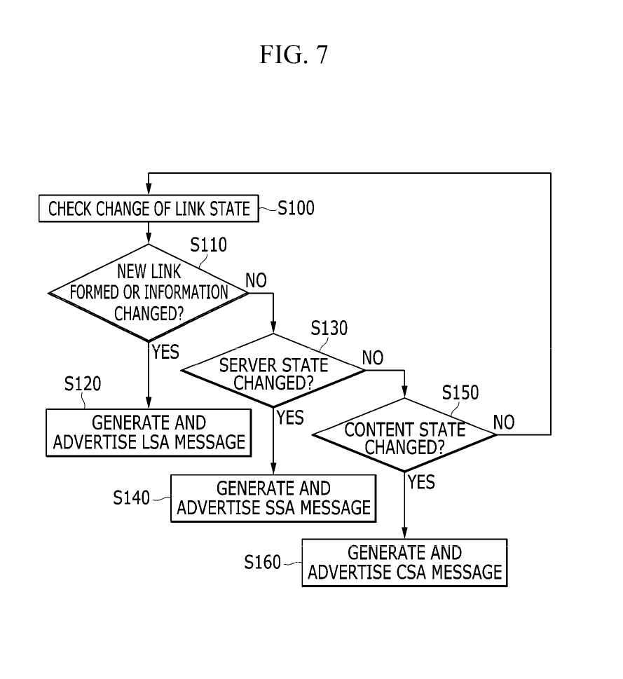

FIG. 6 is a diagram showing a relationship between the smart nodes and the content network management system in an exemplary embodiment of the present invention. The relationship between the smart nodes and the content network management system for collecting information using advertisement messages can be seen through FIG. 6.

The content network management system 200 in accordance with an exemplary embodiment of the present invention includes an advertisement message processing unit 201 for transmitting and receiving advertisement messages as shown in FIG. 6, and further includes an LSDB 200_D1 for managing link state information, an SSDB 200_D2 for managing server state information, and a CSDB 200_D3 for managing content state information.

The advertisement message processing unit 104 of the smart node 100 receives advertisement messages from the advertisement message processing units of adjacent smart nodes and sends its own advertisement message to the advertisement message processing units of adjacent smart nodes, as shown in FIG. 6. Here, the contents of the received advertisement messages are stored in corresponding databases of the smart node 100.

The advertisement message processing unit 201 of the content network management system 200 receives an advertisement message only from a smart node 110 that is physically connected to the content network management system 200. The advertisement message processing unit 201 of the content network management system 200 does not send an advertisement message, but it separates a received advertisement message according to its contents, and stores the separated contents in the corresponding databases LSDB, SSDB, and CSDB.

A smart node 110 (hereinafter called a “relay smart node”, for convenience sake) connected to the content network management system 200 periodically sends the contents of its databases to the content network management system 200, and immediately sends a change in the contents stored in the databases to the content network management system 200 when the change is generated.

Meanwhile, if the content network management system 200 wants to know up-to-date information about the databases, the content network management system 200 must be capable of requesting the information immediately. To this end, the content network management system 200 sends an information request message Mng_Info_Request(DB_id) to the relay smart node connected thereto.

The information request message includes a database identifier. That is, the DB_id parameter within the information request message Mng_Info_Request is an identifier capable of identifying the three databases LSDB, SSDB, and CSDB included in the relay smart node. The relay smart node receives the information request message Mng_Info_Request(DB_id) and propagates the received information request message Mng_Info_Request(DB_id) to adjacent smart nodes. In response to the information request message Mng_Info_Request(DB_id), the adjacent smart nodes propagate information response messages Mng_Info_Reply(DB_info) to the relay smart node. The reception of the information request message and the transmission of the information response message can be performed by the advertisement message processing unit and the processing unit of the smart node. In response to the information request message, each smart node includes the contents of a database, corresponding to a DB_id parameter, in the information response message Mng_Info_Reply(DB_id) and sends the information response message Mng_Info_Reply(DB_id). The DB_info parameter within the information response message Mng_Info_Reply is the contents of a database corresponding to a DB_id parameter.

The information response messages are provided to the content network management system 200 through the relay smart node connected to the content network management system 200. Accordingly, the content network management system 200 can maintain pieces of information about a current network based on the information response messages and finally retain up-to-date information about the network.

A method of collecting information based on the above structure in accordance with an exemplary embodiment of the present invention is described below.

FIG. 7 is a flowchart illustrating a method of collecting information using an advertisement message in accordance with an exemplary embodiment of the present invention.

In an exemplary embodiment of the present invention, if a new link is set up or information about a link is changed at steps S100 and S110, the smart node 100 generates a link state advertisement (LSA) message at step S120.

The LSA message includes information about a specific network interface connected to the smart node, and includes an identifier Inf_ID for a specific interface which is newly formed or whose contents have been changed, the IP address Inf_IP of the specific interface, the interface identifiers of adjacent smart nodes connected to the specific interface, that is, interface identifiers Neighbor_IF of the adjacent smart nodes, the IP addresses of the interfaces of the adjacent smart nodes connected to the specific interface, that is, IP addresses Neighbor_IP of the interfaces of the adjacent nodes, a total bandwidth Total_BW for the specific interface, and an available bandwidth Available_BW for the specific interface. The generated LSA message is advertised over a network.

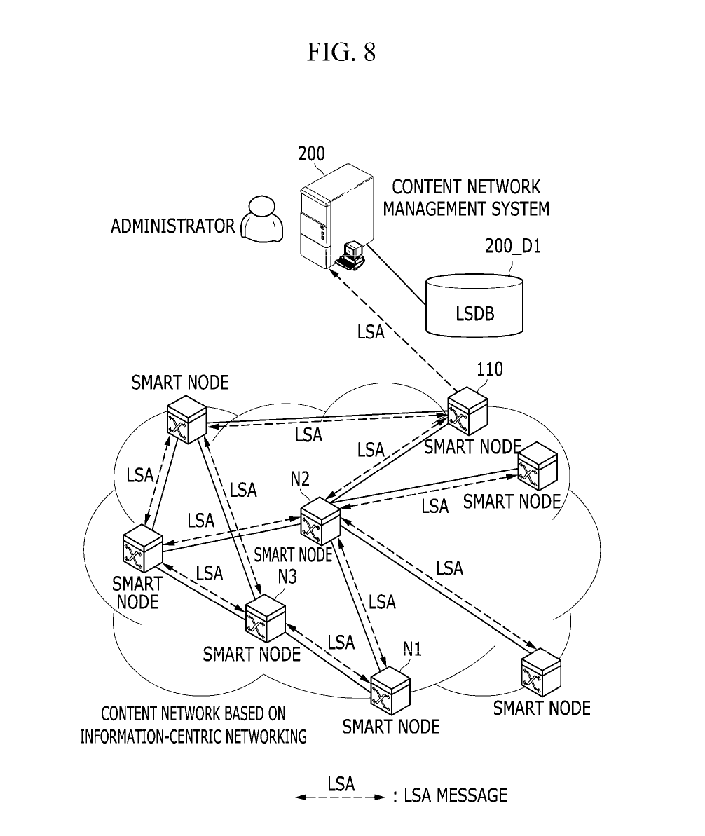

FIG. 8 is an exemplary diagram showing a state in which a link state advertisement (LSA) message is advertised in accordance with an exemplary embodiment of the present invention.

For example, when a smart node N1 generates and advertises an LSA message, smart nodes N2 and N3 adjacent to the smart node N1 receive the advertised LSA message and update their LSDBs based on the received advertised LSA message. Here, the LSA message can include information related to traffic engineering and QoS in addition to a link state. In this case, a traffic engineering (TE)-LSA message can be used. Furthermore, each of the smart nodes N2 and N3 may construct a traffic engineering database (TEDB), that is, a database for storing information related to traffic engineering and QoS, based on the TE-LSA message.

Furthermore, each of the smart nodes N2 and N3 may generate an LSA message in response to a change of information stored in its LSDB that has been updated in response to the received LSA message and advertise the generated LSA message, or may transfer the received LSA message to adjacent smart nodes. In accordance with this process, the LSA messages of smart nodes can be transferred to the content network management system 200 through a relay smart node 110.

Meanwhile, when there is a change in a server state at step S130, the smart node 100 generates a Server State Advertisement (SSA) message at step S140. The SSA message includes a smart node identifier “SmartNode_ID”, the total capacity “Total_Datastore” of the data storage unit for storing content, a capacity “Used_Datastore” currently being used in the data storage unit, a capacity “Used_CPU” used in the processing unit, the total capacity “Total_Memory” of the memory, and a capacity “Used_Memory” currently being used in the memory.

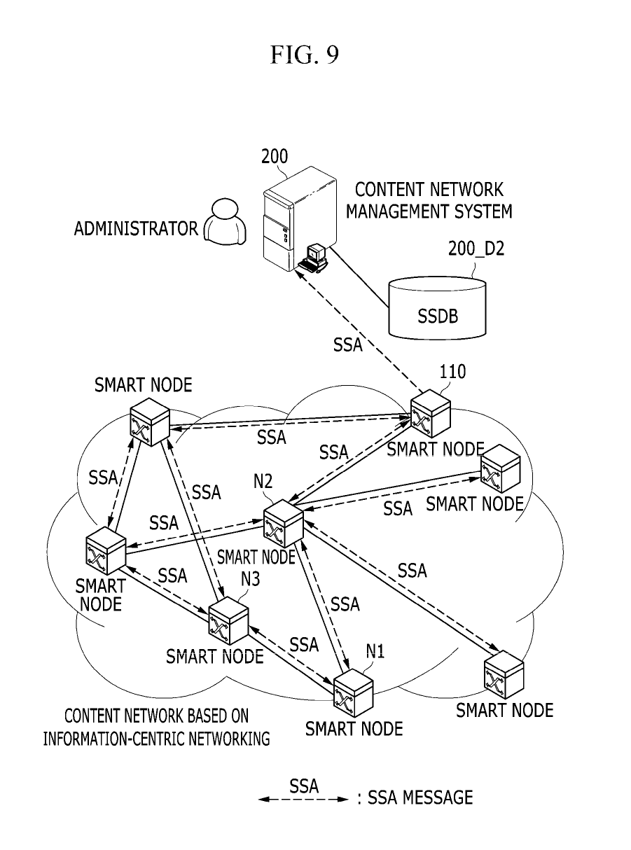

FIG. 9 is an exemplary diagram showing a state in which a server state advertisement (SSA) message is advertised in accordance with an exemplary embodiment of the present invention.

For example, when a smart node N1 generates and advertises an SSA message, smart nodes N2 and N3 adjacent to the smart node N1 receive the advertised SSA message and updates their SSDMs based on the received SSA message.

Furthermore, each of the smart nodes N2 and N3 can generate an SSA message in response to a change of information stored in its SSDB that has been updated in response to the received SSA message and advertise the generated SSA message, or may transfer the received SSA message to adjacent smart nodes. In accordance with this process, the SSA messages of adjacent smart nodes can be transferred to the content network management system 200 through a relay smart node 110.

Meanwhile, when there is a change in the state of content at step S150, the smart node 100 generates a content state advertisement (CSA) message at step S160. The CSA message includes a smart node identifier SmartNode_ID, a content identifier Content_ID, and a chunk identifier Chunk_ID. Content is split into chunks and transmitted. A smart node receives the content, stores the content according to the chunk in the caching storage unit, and serves the content.

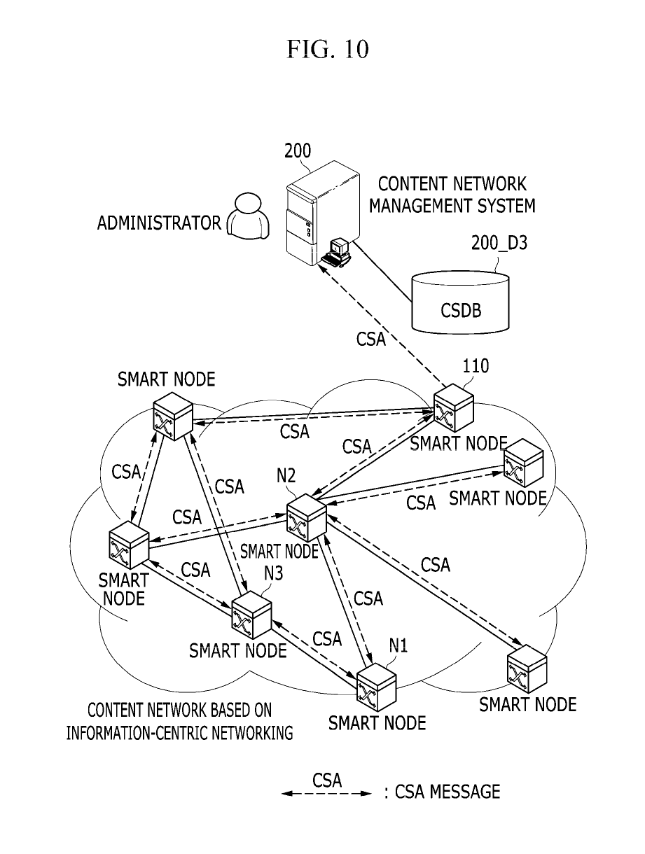

FIG. 10 is an exemplary diagram showing a state in which a Content State Advertisement (CSA) message is advertised in accordance with an exemplary embodiment of the present invention.

For example, when a smart node N1 generates and advertises a CSA message, smart nodes N2 and N3 adjacent to the smart node N1 receive the advertised CSA message and update their CSDBs based on the received CSA message.

Furthermore, each of the smart nodes N2 and N3 can generate a CSA message in response to a change in information stored in its SSDB that has been updated in response to the received CSA message and advertise the generated CSA message, or may transfer the received CSA message to adjacent smart nodes. In accordance with this process, the CSA messages of the smart nodes can be transferred to the content network management system 200 through a relay smart node 110.

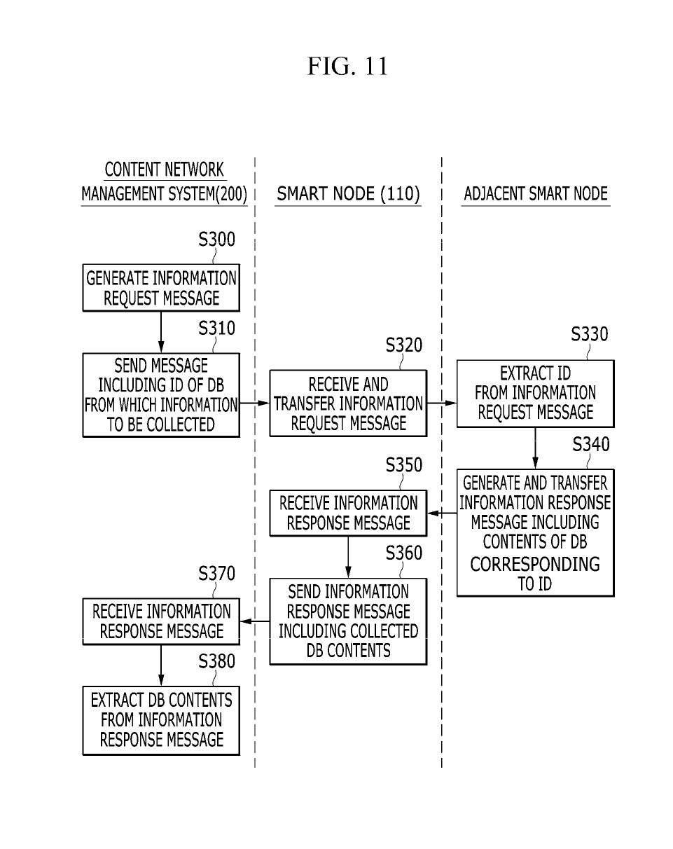

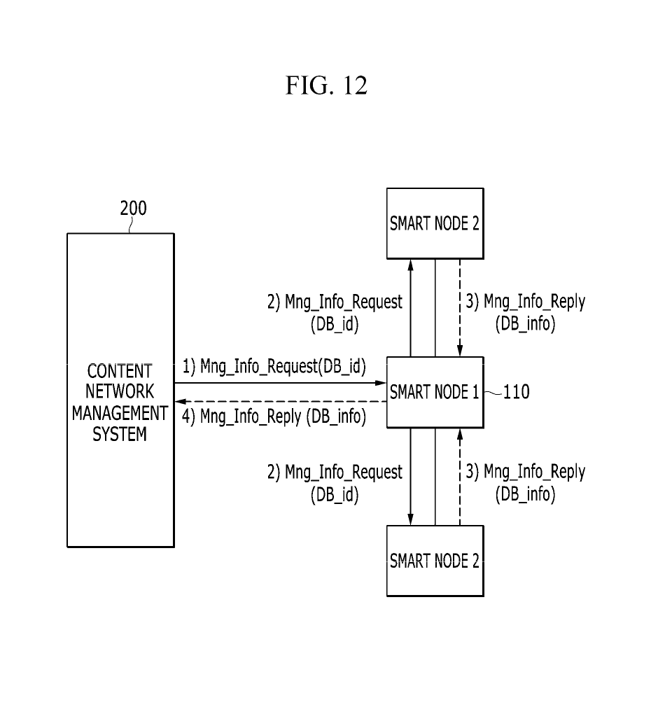

FIG. 11 is a flowchart illustrating a method of collecting information in the content network management system in accordance with an exemplary embodiment of the present invention, and FIG. 12 is a diagram showing a message transmission/reception relationship between the content network management system and smart nodes.

As shown in FIG. 11, if the content management system 200 wants to know up-to-date information about databases, the content network management system 200 generates an information request message at step S300.

In particular, the content network management system 200 generates an information request message Mng_Info_Request(DB_id) including the identifier DB_id of a database to be known, from among the LSDB, SSDB, and CSDB, and sends the generated information request message to a relay smart node 110 connected thereto at step S310, as shown in FIG. 12.

The relay smart node 110 transfers the received information request message to adjacent smart nodes at step S320. Each of the adjacent smart nodes that have received the information request message extracts a database identifier DB_id from the information request message at step S330, generates an information response message Mng_Info_Reply(DB_info) including the contents DB_info of a database (i.e., one of the LSDB, SSDB, and CSDB) corresponding to the extracted database identifier, and sends the generated information response message to adjacent smart nodes at step S340.

As described above, in response to the information request message, each of smart nodes generates an information response message and sends the generated information response message to adjacent smart nodes. In response to the information response message, each of the adjacent smart nodes updates its corresponding database based on the contents of the database that are included in the information response message. Accordingly, each smart node can maintain up-do-date information about a database, generate an information response message including the contents DB_info of the database in which the up-do-date information is stored, and send the generated information response message. Accordingly, as shown in FIG. 12, the relay smart node 110 can receive the information response message, including up-to-date contents stored in a database of each smart node that corresponds to a database identifier DB_id, from each of adjacent smart nodes at step S350.

Accordingly, the relay smart node 110 updates a corresponding database in response to an information response message received from each smart node, generates an information response message Mng_Info_Reply(DB_info) including the contents of the updated database, and sends the generated information response message to the content network management system 200 at step S360.

The content network management system 200 receives the information response message Mng_Info_Reply(DB_info) at step S370, and obtains the contents of DB_info of the database from the received information response message at step S380. As a result, the content network management system 200 can finally maintain pieces of information about a current network and retain up-to-date information about a desired database.

In accordance with an exemplary embodiment of the present invention, information about the resources of smart nodes and information about the topology and network resources of a content network can be integrally collected in a content network based on information-centric networking, and the entire content network can be managed and controlled based on pieces of the information.

The exemplary embodiments of the present invention are not only implemented by way of the method and/or the apparatus, but may be implemented by way of a program for realizing a function corresponding to a construction according to an exemplary embodiment of the present invention or a recording medium on which the program is recorded. The implementations will be evident to a person having ordinary skill in the art to which the present invention pertains from the embodiments. While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of collecting information in a content network over which a plurality of smart nodes is coupled, the method comprising:
each of the smart nodes receiving advertisement messages broadcasted by adjacent smart nodes;
the smart node determining whether each of the received advertisement messages is one of a link state advertisement (LSA) message comprising link state information indicative of a link that is a network interface, a server state advertisement (SSA) message comprising server state information indicative of a data storage state and a processing state of a processing unit of the smart node, and a content state advertisement (CSA) message comprising content state information indicative of content stored in the smart node;
the smart node updating a corresponding database based on the information included in the received advertisement message based on a result of the determination; and
the smart node generating an advertisement message comprising changed information when link state information, server state information, or content state information stored in the smart node is changed in response to the update of the corresponding database and broadcasting the generated advertisement message.

2. The method of claim 1, wherein the smart node retains link state information, server state information, and content state information about all the smart nodes connected to the content network based on the advertisement messages broadcasted by the respective smart nodes.

3. The method of claim 1, wherein
a content network management system is only connected to a relay smart node that is one of the plurality of smart nodes, and
the method further comprises the content network management system obtaining the link state information, the server state information, and the content state information about the smart nodes connected to the content network based on the advertisement messages broadcasted through the relay smart node.

4. The method of claim 1, wherein updating the corresponding database comprises:
updating its own link state database based on contents included in the LSA message if, as a result of the determination, the received advertisement message is the LSA message;
updating its own server state database based on contents included in the SSA message if, as a result of the determination, the received advertisement message is the SSA message; and
updating its own content state database based on contents included in the CSA message if, as a result of the determination, the received advertisement message is the CSA message.

5. The method of claim 1, wherein the link state information comprises at least one of an identifier of a first interface which is newly formed in the smart node or whose contents have been changed, an IP address of the first interface, adjacent node interface identifiers that are interface identifiers of adjacent smart nodes connected to the first interface, IP addresses of adjacent node interfaces that are IP addresses of interfaces of adjacent smart nodes connected to the first interface, a total bandwidth of the first interface, and an available bandwidth of the first interface.

6. The method of claim 1, wherein the server state information comprises at least one of a smart node identifier, total capacity of a data storage unit for storing content, capacity of the data storage unit currently being used, an amount of a processing unit being used, total capacity of a memory, and capacity of the memory being used.

7. The method of claim 1, wherein the content state information comprises a smart node identifier, a content identifier, and a chunk identifier.

8. A method of collecting information in a content network over which a plurality of smart nodes is coupled, the method comprising:
a content network management system connected to a relay smart node, that is, one of the plurality of smart nodes, generating an information request message, and sending the generated information request message to the relay smart node; and
the content network management system receiving an information response message corresponding to an information request message through the relay smart node,
wherein the information request message comprises an identifier of one of a database for storing link state information indicative of a link that is a network interface, a database for storing server state information indicative of a data storage state and a processing state of a processing unit of each smart node, and a database for storing content state information indicative of content stored in each smart node, wherein the databases are included in the content network management system.

9. The method of claim 8, wherein the information response message comprises database contents that are one of link state information, server state information, and content state information corresponding to a database identifier included in the information request message.

10. The method of claim 8, further comprising:
the relay smart node receiving the information request message from the content network management system;
the relay smart node sending the received information request message to adjacent smart nodes;
the relay smart node receiving the information response message corresponding to the information request message from an adjacent smart node; and
the relay smart node sending the information response message to the content network management system.

11. The method of claim 10, wherein the relay smart node sending the information response message to the content network management system comprises:
the relay smart node updating its own corresponding database based on database contents included in the information response message received from the adjacent smart node;
the relay smart node generating an information response message comprising the updated database contents; and
the relay smart node sending the generated information response message to the content network management system.

12. A node apparatus connected to a content network over which a plurality of smart nodes is coupled, comprising:
a link state database for storing link state information about a link that is a network interface connected to a specific smart node of the content network;
a server state database for storing server state information indicative of a data storage state and a processing state of a processing unit of the specific smart node of the content network;
a content state database for storing content state information indicative of content stored in the specific smart node of the content network;
an advertisement message processing unit for sending an advertisement message comprising information related to a generated change when one of the link state database, the server state database, and the content state database is changed, and receiving advertisement messages from other smart nodes; and
a processing unit for updating one of the link state database, the server state database, and the content state information database based on the information included in the received advertisement message.

13. The node apparatus of claim 12, further comprising:
a caching storage unit for receiving content in a chunk unit and caching the received content;
a data storage unit for storing data including the content; and
a memory.

14. The node apparatus of claim 12, wherein if an information request message generated from a content network management system connected to a relay smart node that is one of the plurality of smart nodes is received, the node apparatus sends an information response message comprising contents of a database corresponding to a database identifier included in the information request message, from among the link state database, the server state database, and the content state database.

15. The node apparatus of claim 12, wherein the node apparatus stores and manages pieces of link state information, server state information, and content state information about all the smart nodes connected to the content network in respective databases.
